(19) United States
(12) Patent Application Publication
(10) Pub. No.: US 2021/0097605 A1
(43) Pub. Date: Apr. 1, 2021

(54) POLY-STRUCTURED DATA ANALYTICS

(71) Applicant: Wells Fargo Bank, N.A., Charlotte, NC (US)

(72) Inventors: Naveen Gururaja Yeri, Charlotte, NC (US); Fordjour Y. Kyei, Eden Prairie, MN (US); Robert John Carlson, Jr., Lakeville, MN (US); Kevin Hale, Dublin, OH (US); Pamela Niska, Edina, MN (US); Dave A. Hall, Gilbert, AZ (US); Rebecca Snow, Minnetonka, MN (US)

(21) Appl. No.: 15/080,093

(22) Filed: Mar. 24, 2016

(51) Int. Cl. G06Q 40/02; G06F 17/30

(52) U.S. Cl. CPC G06Q 40/025; G06F 17/30528; G06F 17/30687; G06F 17/30702

(57) ABSTRACT

Systems and methods that facilitate determining and predicting fraudulent or non-compliant behavior using poly-structured data analytics are discussed. An unstructured data steam comprising a set of emails can be received, and processed to reduce the noise, or non-relevant portions of the dataset. Structured data that includes contextual relevant information about the users can also be received, and the poly-structured data modeling system can identify unstructured variable and structured variables that are relevant for identifying and predicting non-compliant behavior. These unstructured and structured variables can then be modeled in order to identify communications that may contain non-compliant and/or fraudulent behavior.

### BACKGROUND

Federal regulatory agencies have increased their scrutiny of lending practices and so financial institutions are expected to monitor electronic communications for potential instances of non-compliant and fraudulent behavior. Searching large sets of emails can be difficult, as rule based, keyword searching algorithms, may return large numbers of false positive results, as well as potentially large numbers of false negatives.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

The disclosure disclosed and claimed herein, in one aspect thereof, includes systems and methods that facilitate monitoring, detecting, and predicting instances of non-compliant or fraudulent behavior based on analyzing electronic communications to or from financial institution employees. The fraud risk management system and method disclosed herein can use poly-structured data analytics, using both unstructured data and structured data in order to monitor for non-compliant or fraudulent behavior. The fraud risk management system can first ingest the email datasets and perform basic processing to split the datasets into headers, email bodies, and attachments. The system can also perform noise reduction processing to remove emails and portions of the dataset that may not be relevant to fraud detection and monitoring.

After the unstructured dataset has been reduced in size, it can be combined with structured data that includes various contextual details about the employees that can be used to facilitate predicting non-compliance and fraud. The unstructured and structured data can then be modeled using several different techniques such as topic, sequence and anomaly detection modeling among other modeling tools, with sentiment, skipgrams, maxent and text classifiers to generate a non-compliant behavior risk score. The risk score generated by the poly-structured data analytics can be more accurate and deliver fewer false positives and negatives than modeling using just unstructured data or structured data.

For these considerations, as well as other considerations, in one or more embodiments, a system for performing fraud risk management using poly-structured data analytics can include a memory to store computer-executable instructions and a processor, coupled to the memory, to facilitate execution of the computer-executable instructions to perform operations. The operations can include receiving a dataset comprising a set of emails associated with a user, wherein the dataset is unstructured data. The operations can also include performing noise reduction on the dataset, wherein the noise reduction removes a portion of the dataset that is not relevant to fraud risk management and receiving a set of contextual data associated with the user, wherein the contextual data is structured data. The operations can also include determining a fraud risk score based on an analysis of the dataset and the contextual data, wherein the analysis is based on an unstructured variable of the unstructured data and a structured variable of the structured data.

In another embodiment, a method for determining non-compliance using poly-structured data analytics can include receiving, by a device comprising a processor, a set of unstructured data comprising a set of emails associated with a user and filtering, by the device, a portion of the set of unstructured data that is related to determining non-compliance. The method can also include receiving, by the device, a set of structured data comprising contextual data about the user and determining, by the device, a non-compliance risk score based on an analysis of the set of unstructured data and the set of structured data.

In another embodiment, a non-transitory computer-readable medium configured to store instructions, that when executed by a processor perform operations including, receiving a dataset comprising a set of emails associated with a user, wherein the dataset is unstructured data. The operations can also include performing syntactic noise reduction filtering, static semantic noise reduction filtering, and dynamic semantic noise reduction filtering on the dataset to remove a portion of the dataset that is not relevant to fraud risk management. The operations can also include determining a sentiment score associated with an email of the set of emails and performing a word analysis on the email of the set of emails. The operations can also include receiving a set of contextual data associated with the user, wherein the contextual data is structured data and determining a fraud risk score based on the sentiment score, the word analysis and a contextual variable of the set of contextual data.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is an illustration of an example system for poly-structured data analytics in accordance with one or more aspects of the disclosure.

FIG. 2 is an illustration of an example flow chart of a method for data ingestion for poly-structured data analytics, according to one or more embodiments.

FIG. 3 is an illustration of an example system for fraud risk management using poly-structured data analytics in accordance with one or more aspects of the disclosure.

FIG. 4 is an illustration of an example noise reduction component in a fraud risk management system in accordance with one or more aspects of the disclosure.

FIG. 5 is an illustration of an example word analysis component in a fraud risk management system in accordance with one or more aspects of the disclosure.

FIG. 6 is an illustration of an example system for fraud risk management using poly-structured data analytics in accordance with one or more aspects of the disclosure.

FIG. 7 is an illustration of an example results output of a fraud risk management system in accordance with one or more aspects of the disclosure.

FIG. 8 is an illustration of an example flow chart of a method for fraud risk management using poly-structured data analytics, according to one or more embodiments.

FIG. 9 is an illustration of an example computing environment where one or more of the provisions set forth herein are implemented, according to one or more embodiments.

FIG. 10 is an illustration of an example computing environment where one or more of the provisions set forth herein are implemented, according to one or more embodiments.

### DETAILED DESCRIPTION

The following terms are used throughout the description, the definitions of which are provided herein to assist in understanding various aspects of the disclosure.

As used in this disclosure, the term “device” refers to devices, items or elements that may exist in an organization's network, for example, users, groups of users, computer, tablet computer, smart phone, iPad®, iPhone®, wireless access point, wireless client, thin client, applications, services, files, distribution lists, resources, printer, fax machine, copier, scanner, multi-function device, mobile device, badge reader and most any other networked element.

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein, it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

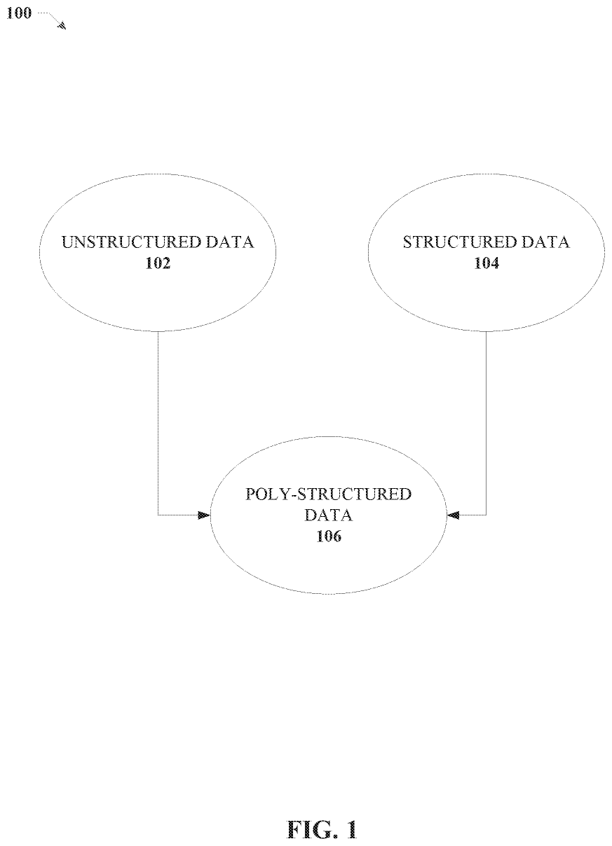

With reference now to the figures, FIG. 1 is an illustration of an example system 100 for poly-structured data analytics in accordance with one or more aspects of the disclosure.

System 100 includes unstructured data 102 and structured data 104 that can be combined to form poly-structured data 106. The data 102, 104, and 106 can be stored in one or more memories or data repositories on a network, for example, a local area network, campus area network, wide area network, enterprise private network, intranet, extranet, the Internet or most any other network. The devices, components, and databases of system 100 can be connected to and communicate with one another via a network.

Devices, as referred to herein can include most any device, item or element in an organization's network, for example, users, groups of users, computer, tablet computer, smart phone, iPad®, iPhone®, wireless access point, wireless client, thin client, applications, services, files, distribution lists, resources, printer, fax machine, copier, scanner, multi-function device, mobile device, badge reader and most any other network element. In an embodiment, devices can include devices running the Windows® operating system and devices having non-Windows operating systems.

Unstructured data 102 can refer to information that does not have a pre-defined data model or is not organized in a pre-defined manner. Unstructured information is typically text-heavy, but may contain data such as dates, numbers, and facts as well. This results in irregularities and ambiguities that make it difficult to understand using traditional programs as compared to data stored in fielded form in databases or annotated (semantically tagged) in documents. In embodiments herein, unstructured data can be data received via email, such as email headers, metadata, email text, attachments, and other information associated with electronic communications.

The unstructured data 102 in FIG. 1 can be data comprising emails sent to and from employees of a financial institution. The employees can be selected based on regulatory concerns, i.e., employees that have the capability of committing fraud or non-compliant behaviors based on federal regulations. Once the employees have been selected, their emails can be copied to data repositories for analysis. Outbound and inbound emails can be collected, and converted into pst files (Personal Storage Table).

Structured data 104 can be data that is organized into columns, rows, and other structural formats which can be easily ordered and processed by data mining tools. In the embodiment herein, structured data 104 can include data about the users associated with the email dataset. For instance, the structured data 104 can include contextual information such as application characteristics, Fraud scores, previous dispositions, demographic, geographic and survey results.

While both unstructured data 102 and structured data 104 can be predictive for determining non-compliant behavior or detecting fraud, poly-structured data 106 is even more predictive, and more predictive than the sum of both unstructured data 102 and structured data 104. After modeling, combination of unstructured and structured data variables yielded super additive fit, suggesting that the structured and unstructured data provide complimentary information to the model.

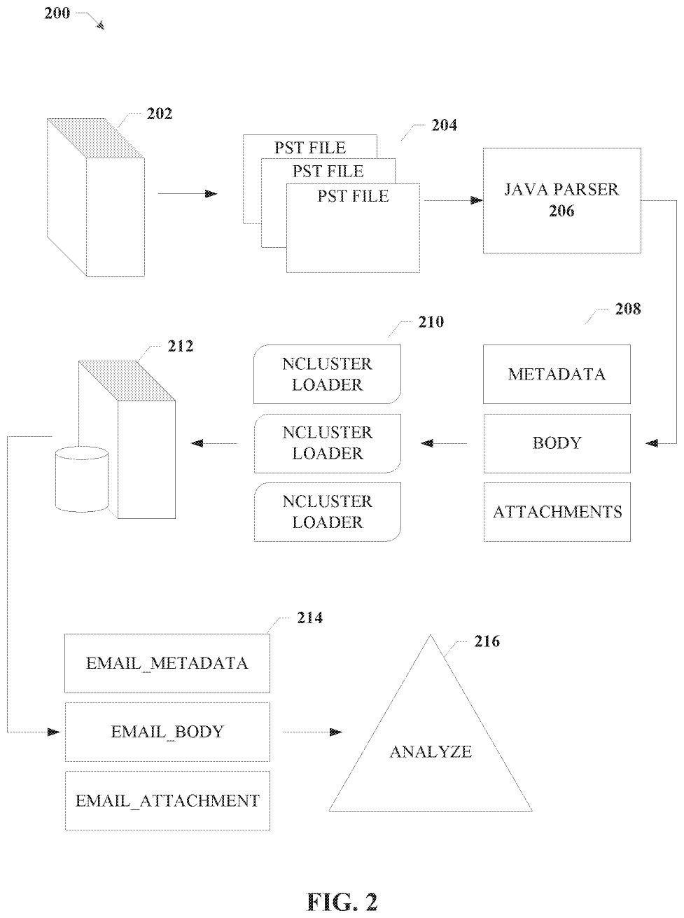

Turning now to FIG. 2, illustrated is an example flow chart of a method 200 for data ingestion for poly-structured data analytics, according to one or more embodiments. Emails can be the main source of data for unstructured data, and can comprise both inbound and outbound emails from users associated with the fraud risk management system. The emails can be collected from an exchange server and saved to a UNIX directory 202, where the pst files can be hosted and processed. A JAVA parser 206 can process the pst files 204 in order to split the emails into metadata, body, and attachment portions at 208. These can be further stripped of their journaled layers and converted into text files and then loaded into a database using ncluster loaders at 210. At 212, this is where noise reduction is first performed on the data, and then processed to determine sentiment analysis, where other word and text analytics are performed. At 214, the emails have been split into email_metadata, email_body, and email_attachment portions and then the unstructured data is analyzed for fraud risk at 216.

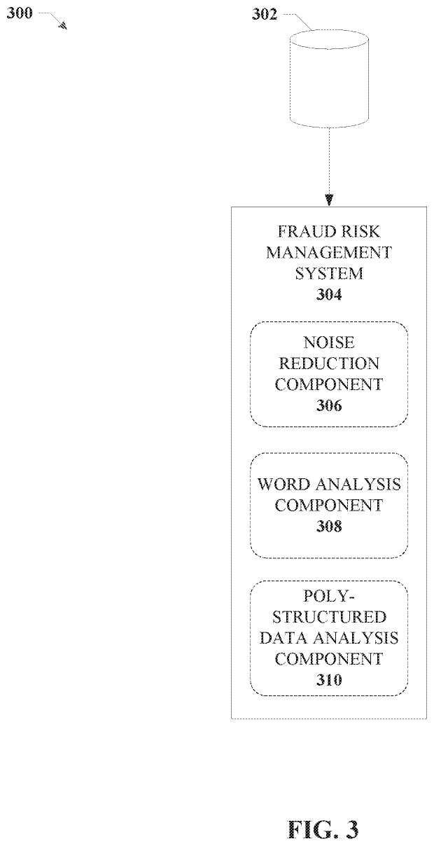

Turning now to FIG. 3, illustrated is an example system 300 for fraud risk management using poly-structured data analytics in accordance with one or more aspects of the disclosure. In an embodiment, a fraud risk management system 304 can receive an unstructured dataset from a memory 302. The unstructured dataset can include emails to and from users that are being monitored for non-compliant behaviors and/or fraud. The memory 302 can be a database or server that hosts the emails (e.g., UNIX directory 202).

The fraud risk management system 304 can include a noise reduction component 306 that performs noise reduction on the dataset, where the noise reduction component 306 removes a portion of the dataset that is not relevant to fraud risk management. As an example, noise reduction component 306 can use adaptive algorithms to automatically detect noisy data such as automatic replies, failed delivery messages, your mailbox is full etc. The noise reduction component 306 can also use time-stamps, sender email and subject of the email for reducing false positives. In other embodiments, the noise reduction component 306 can remove portions of the dataset (i.e., remove emails or portions of emails) based on key words (e.g., welcome, good morning), coupled with footnotes, signatures (e.g., “thank you”), and disclaimers are identified and broken out by paragraphs and put into lookup tables. These tables can then be used to filter out key words/phrases and syntax that look like noise. In other embodiments, the noise reduction component 306 can provide adaptive learning (using machine learning algorithms) for the removal of noisy data where algorithms adapt and learn where to look for noise.

The fraud risk management system 304 can also include a word analysis component 308 configured to analyze the dataset based on keywords and key phrases, perform sentiment analysis to determine the mood of particular communications, and also search, rank, and order high risk words, phrases, and themes. The word analysis component 308 can also track changes in mood, phrases used, words used, and etc. over time in order to identify trends. These trends can be analyzed for sudden shifts and gradual ramp-ups which can be predictive for non-compliant behavior and fraud.

The fraud risk management system 304 can also receive structured data, or contextual data about the users associated with the emails and poly-structured data analysis component can combine the unstructured data with the structured data, associating together the emails with the contextual data and determine a fraud risk score based on an analysis of the dataset and the contextual data, wherein the analysis is based on unstructured variables of the unstructured data and structured variables of the structured data.

The unstructured variables can be based on a result of the word analysis, and can be based on a combination of skip-gram modeling, ngram text analysis modeling, topic modeling (e.g., latent dirichlet allocation modeling), maximum entropy text classification modeling, sentiment analysis, anomaly detection, sequence modeling which are all put together in a generalized linear model/logistic regression model. The structured variables can be based on application, fraud case history, demographics, financial attributes, internal/external feedback and previous non-compliance. With previous non-compliance, or suspected non-compliance, how long ago the investigation occurred can also be a relevant factor in determining fraud risk.

In other embodiments, the structured variable can also be based on the percentage of loans that are granted through a interest rate reduction refinance loan program, the percentage of loans which are duplicate submitted, the months that the user is at a specific position, the number of previous investigations due to fraud or suspected fraud, whether or not the investigations were in the previous six months, the number of three-step loans, fraud scores, total number of loans throughput, percentage of loans funded, team member earnings over one year, and high team member earnings.

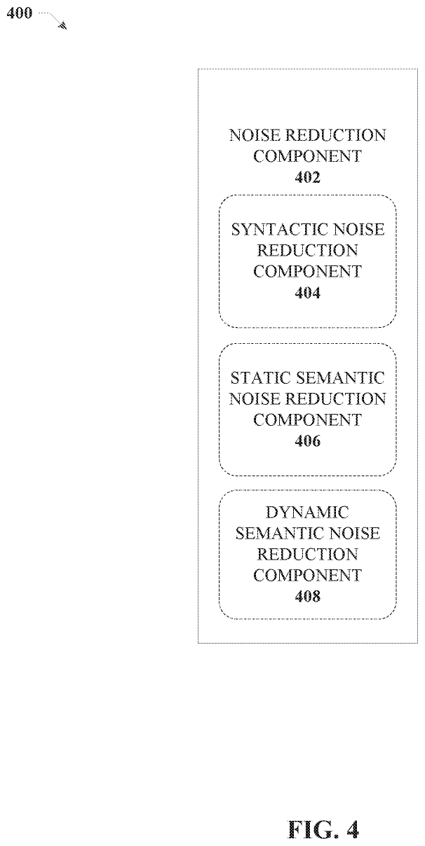

Turning now to FIG. 4, illustrated is an example noise reduction component 402 in a fraud risk management system 400 in accordance with one or more aspects of the disclosure. The exemplary noise reduction component 402 can be an example of the noise reduction component 306 shown in FIG. 3 above. The noise reduction component 402 can include a syntactic noise reduction component 404, a static semantic noise reduction component 406, and a dynamic semantic noise reduction component 408.

Syntactic noise reduction component 404 can performs noise reduction on the dataset, where the noise reduction removes a portion of the dataset that is not relevant to fraud risk management. In an embodiments, syntactic noise reduction component 404 can search through the unstructured dataset for phrases that are indicative of emails that are automatically generated by one or more systems. Such phrases can include messages that inboxes are full, failed delivery messages, status messages, original message tags, automatic replies, and etc. These messages and/or portions of messages can be removed from the dataset to make the dataset smaller and more manageable. In an embodiment, syntactic noise reduction component 404 can adaptively learn and look for high frequency, repetitive words and phrases that are system generated, and store the keywords in a database. The syntactic noise reduction component 404 can then check new emails against the database for matching keywords and phrases and then delete the portions of the messages/electronic communications that contained the matching phrases.

Static semantic noise reduction component 406 can perform noise reduction on the dataset based on keywords (“welcome”, “good morning”, etc.) coupled with footnotes, signatures, and disclaimers in order to remove portions of emails that are not relevant to fraud risk management. Email data is split up into paragraphs, where the paragraphs are indexed and sorted by the minimum indexed paragraphs and put into tables. Lookup tables can be created at the first eligible line number in the table that looks like noise. Non-noisy paragraphs in the table can be filtered out to occur before noisy ones if any keywords/phrases, and syntax looks like noise. Afterwards, the non-noisy paragraphs can be put back together in the dataset to form the original email without the noise.

Dynamic semantic noise reduction component 408 can use adaptive learning (using machine learning algorithms) for the removal of noisy data that was not caught/identified by the syntactic noise reduction component 404 and the semantic noise reduction component 406. The dynamic semantic noise reduction component 408 can use algorithms that adapt and learn where to look for, how to identify, split from and eliminate noise where both the syntactic and semantic noise reduction algorithms left off.

The dynamic semantic noise reduction component 408 can split email chains based on the header information (split at the From:, Sent:, Date:, To:, Subject: etc.) in this order using the dynamic semantic noise reduction approach and then noise is identified and removed using machine learning algorithms. A column is created in a table where the clean non-noisy split up emails are dumped and arranged in historical order, so that the oldest email in the chain has the biggest row value and newest email in the chain is on the top.

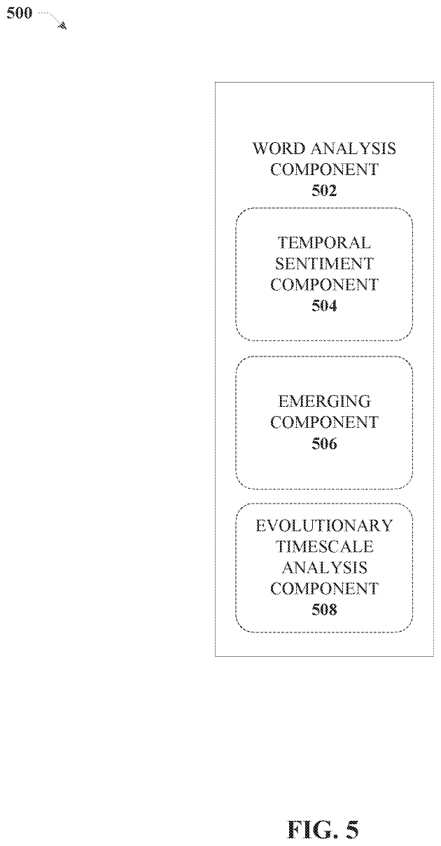

Turning now to FIG. 5, illustrated is an illustration of an example word analysis component 502 in a fraud risk management system 504 in accordance with one or more aspects of the disclosure. The exemplary word analysis component 502 can be an example of the word analysis component 308 shown in FIG. 3 above. Word analysis component 502 can include a temporal sentiment component 504, an emerging component 506, and an evolutionary timescale analysis component 508.

Temporal sentiment component 504 can examine the split email chains (as split by dynamic semantic noise reduction component 408) to determine the sentiment of emails sent by the users. The periods of context around each email are examined using historical sentiment components for each time period, and the average sentiment scores for each time period are computed for each email within the period.

Sentiment analysis use natural language processing, text analysis and computational linguistics to identify and extract subjective information in the dataset. Sentiment analysis can determine the attitude of the user with respect to some topic or the overall contextual polarity of the email. The attitude may be his or her judgment or evaluation, affective state (that is to say, the emotional state of the user when writing), or the intended emotional communication (that is to say, the emotional effect the user wishes to have on the reader).

Temporal sentiment extraction, as performed by the temporal sentiment component 504 can be successful in predicting noncompliance on its own, but also with topic variables determined by the emerging component 506 and the evolutionary timescale analysis component 508. Generally, emails with negative sentiment received over a previous day is considered a medium risk for noncompliance with just the unstructured modeling. But emails received with negative sentiment over the previous day, when combined with the structural dataset analytics in the poly-structured modeling, are indicative of a much higher risk of noncompliance. When negative sentiment is followed very quickly by positive sentiment, the modeling suggests that hiding of noncompliant behavior is occurring.

Emerging component 506 can perform topic modeling which searches, ranks, and orders high risk words, phrases, and themes. The emerging component 506 can employ latent dirichlet allocation (“LDA”) that allows sets of observations to be explained by unobserved groups that explain why some parts of the data are similar. For example, if observations are words collected into documents, it posits that each document is a mixture of a small number of topics and that each word's creation is attributable to one of the document's topics.

LDA is a Bayesian model which models the generative process for words in a document as: randomly choose a topic z_i (bag of words) from the set of topics z in proportion to the vector of topic probabilities Z; from t_i, randomly choose a word w_i from the set of words w(z_i) belonging to z_i, according to the vector of word probabilities W(z-i). For a collection of documents D, a given number of topics n, and two hyperparameters α and β which impose soft limits respectively the number of words to a topic and the number of topics to a documents, LDA learns without supervision the topic model that maximizes the likelihood of the documents D subject to the Dirichlet prior parameterized by α and β. because the prior penalizes sparse assignment of topics to documents and words to topics while the likelihood function encourages sparsity where it would increase likelihood, the optimal penalized likelihood model clusters highly co-occurring words to a topic. The result is that LDA learns the optimal n topics, and the vectors of probabilities Z and W that indicate respectively the relative amount of focus given to topics in a document, and the relative importance of a word to a given topic.

The LDA functionality performed by the emerging component 506 can be implemented in three functions: LDATrainer, LDATopicPrinter, and LDAInference. LDATrainer takes as argument a document set represented as a table of word*document tuples, and returns the LDA model object table; and an optional topic distribution table for the training set. LDA Topic Printer returns for a model table a representation table that gives the n most frequent words from each topic together with their (optional) probabilities. LDAInference applies a given topic model table to a novel test set to yield a topic distribution for the test set.

In the context of a regression analysis bridging structured and unstructured data, LDA serves as a de-dimensionalizer: it enables a document to be represented as a small set of topic distributions rather than a very large and noisy set of words. This is of potential special value in the compliance text analytics setting, where bad actors are believed to be evolving and obfuscating the words and phrases they use to transact non-compliance; LDA clusters that bring together related words should more effectively map onto non-compliant acts.

Although LDA topic proportions could themselves be utilized as independent variables in a logistic regression, this formulation is unlikely to be helpful. Any given topic from the topic modeler is much more likely than the non-compliance it needs to signal, so modeling raw proportions of topics as independent variables is inappropriate. The rarity of non-compliance itself suggests that the best predictors are likely to be outliers themselves.

Therefore, independent variables are modeled whether the email contained an unusual prevalence of a given topic, where unusual is defined as greater than one standard deviation above the mean prevalence across the document set. Here, a percentile function is utilized to find the one standard deviation above values for prevalence for each topic, then a join from this table to the data table, returning true if one standard deviation above for that topic for that document, false otherwise. These values are then passed as independent variables into a logistic regression model.

The emerging component 506 can also use anomaly detection modeling which is the use of statistical and machine learning techniques to find data points and instances which are deviate or anomalous in some sense. Typically, unsupervised anomaly detection algorithms are trained only with a dataset of normal instances, whereas supervised anomaly detection methods additionally utilize a set of instances labelled as anonymous.

In the context of non-compliance detection and topic modeling, a simple anomaly detection approach can be used to derive from topic distributions an interesting set of features. In topic modeling, a given email document can be associated with multiple topics. Given the small set of topics, their overlapping nature, and the rarity of non-compliance, it is not clear that linear increases in the proportion of a topic should ever yield logit-proportional increases in the likelihood of non-compliance. It is more likely that unusual emphasis given to a particular topic is likely an indicator of non-compliance. The per-document topic proportions returned by LDATraining are discretized at training time and LDAInference at test time into a per-document vectors of binary topic-anomaly features. The 50 (median) and 84 (1-standard deviation above median) percentiles of per-document topic proportions for each topic are found and then, for each document, for each topic, return true (1) if the document-topic proportion exceeds the median proportionality for the topic by one standard deviation, false (0) otherwise.

The emerging component 506 can also perform maximum entropy text classification (MaxEnt). Max Ent is a generalization of Logistic Regression (which is a binary classification method) to multiclass problems (Multinomial Logistic Regression.)

Like other forms of regression analysis, it makes use of one or more predictor variables that may be either continuous or categorical. Unlike ordinary regression, it's used for predicting categorical outcomes of the dependent variable rather than continuous outcomes.

In the context of text classification with two possible classes (e.g. 1 or TRUE for documents about basketball, and 0 or FALSE for documents that are not about Basketball), learning a MaxEnt text classifier involves learning the appropriate weights (the weight vector β in FIG. 3.) associated with each word (the activation vector X) as evidence for/against the class. For example, the classifier might learn +1.2 as a weight for (“dribble”, TRUE), meaning that the word “dribble” supplies relatively strong (1.2 is a large logit) positive (the sign of the logit is +) evidence for the class TRUE. These logit weights range from negative to positive infinity, and are commonly exponentiated to yield the score of the evidence for a particular class, as reflected in the numerator of the equation in EQN: 1.

$$\begin{matrix}Pr ( {Y}_{i} = 0 ) = \frac{{e}^{{β}_{0 \cdot {X}_{i}}}}{{e}^{{β}_{0 \cdot {X}_{i}}} + {e}^{{β}_{1 \cdot {X}_{i}}}} \\ Pr ( {Y}_{i} = 1 ) = \frac{{e}^{{β}_{1 \cdot {X}_{i}}}}{{e}^{{β}_{0 \cdot {X}_{i}}} + {e}^{{β}_{1 \cdot {X}_{i}}}} \\ \end{matrix} \qquad EQN : 1$$

This score is renormalized into a probability by dividing by the summed exponentiated score for all classes: the 1/TRUE case and the 0/FALSE case. This classifier is a learned iterative gradient ascent routine which on every iteration adjusts weights to minimize the difference between the expected model (the classes predicted by the current iteration of the model for each instance) and the empirical model (the actual data classes associated with each instance).

In the context of text classification with multiple classes (e.g. BASKETBALL for documents about basketball, HOCKEY for documents about hockey, and SOCCER for documents about soccer), MaxEnt or multinomial logistic regression generalizes binomial logistic regression as a set of for/against decisions for each class against all the others. For example, in EQN: 2, the evidence for a particular class c is reflected in the numerator, analogous to the numerator in EQN: 1 the only substantive change for the multinomial case is in the denominator, where the renormalization value is the sum of weighted activations over all classes in the model.

$$Pr ( {Y}_{i} = c ) = \frac{{e}^{{β}_{{e}^{ } \cdot {X}_{i}}}}{{\sum }_{h} {e}^{{{β}_{h}}^{ } \cdot {X}_{i}}} \qquad EQN : 2$$

The emerging component 506 can also use skipgram modeling, where skipgrams are a generalization of the ngram concept in natural language processing. An ngram is a n-word sequence of text, which can be used to provide greater context in e.g. a sequential part of speech or named entity recognition task, or can be used to provide more accurate features for text classification. As an example of the latter, “bounce pass” as a feature for the previous text classification example is indicative of the BASKETBALL class in a way that can't be predicted from the unigram features “bounce” or “pass”, each of which could be indicative of HOCKEY or SOCCER.

Skipgram modeling generalizes the ngram concept by allowing an n-word window for co-occurrence rather than strict adjacency in the text. The skipgram capability is especially applicable in the non-compliant behavior/fraud context where a discovered skipgram such as pad*fee behaves like data loss prevention rules and are particularly adept at modeling the variation and evolution (pad the most recent fee, padded brokerage fee) in phrasings that non-compliant team members use to transact non-compliance. Such skipgrams typically have a maximum window size (herein 6 words) including the elements of the skipgram.

A representative set of skipgrams can be derived from a text by the following procedure: 1. Pass the text through ngram with length 6 to derive a set of ‘spangrams’; 2. Treat each spangram as a separate document and pass through a text parser to derive the individual words for each spangram together with an index of the spangram (and the document) and an index for each component word (1 through 6). 3. Use generate_series to create a 26 member truth table of skipgram ‘schemas’ such that each schema indexes a particular subset of elements (i.e. TFTTFT corresponds to the 1^{st}, 3^{rd}, 4^{th}, and 6^{th} elements of the spangram), for all possible combinations of elements, minus unigrams (32-6); 4. Cross join each spangram component set to this truthtable; 5. Clean up and concatenate each component set in this join to yield a skipgram in the following notation: a*b*c, where a, b, etc. . . . refer to individual words and * designates any number of intervening words including 0, such that all star lengths sum to 6—the #of words in the skipgram.

For example, to find the skipgram pad*fee, it is enough to 1. find from ngram a spangram please pad the mortgage origination fee; 2. Parse this spangram into words please,pad,the,mortgage,origination fee; 3. Generate the 26 member truth table; 4. For this spangram, grab all 26 possible skip multigrams: please pad, please the, . . . up to the skipgram which contains all 6 words (is equal to the total spangram). 5. Clean up and concatenate each skipgram: pad*fee.

Utilizing skipgram features in a machine learning classifier has challenges, however. By definition, the set of skipgrams feature derived from a document set will be a highly correlated feature set, which is a major challenge for statistical machine learning routines such as MaxEnt and is still a challenge for non-statistical machine learning routines such as Random Forest. This correlation is due to the massive overlapping nature of skipgrams from their definition: pad*brokerage*fee contains pad*fee, etc. . . . , and are thus likely to be very highly correlated, moreso than even n-grams because of the greater number of ways skipgrams can overlap.

A type of skipgram modeling that the emerging component 506 can perform is Random Forest, which is a non-probabilistic classifier which itself generalizes the popular decision tree algorithm. For a given (binary) feature set, a decision tree iteratively applies splitting criterion (Entropy, Gini coefficient) to determine which feature provides the most discriminative partition over the training data at each step. The best feature is assigned to the current node and each binary value of that feature is assigned to one of the two branches from that node, with the data partitioned to each node according to the value of the connecting branch. This procedure is then iterated on each sub-node so that the decision tree grows and continues to sub-partition the data, until either each node of the tree corresponds to one label (providing a total classification for each possible feature path) or another stopping criterion (in what is often called a ‘pruned’ tree). To apply a decision tree to predict the class of a test item, the feature vector is ‘read off’ the tree from root node to frontier, following the path down the tree to the leaf with the corresponding label for that class.

A random forest generalizes this concept by building a set of decision trees, where each decision tree is given a random subset of the features and a random subset of the data, and returning the majority prediction from this ensemble. The key advantage of the random forest algorithm is that the random partitioning of the data to the trees makes the ensemble more tolerant of noise, because the trees which overfit noise in the data will tend to ‘cancel’ each other, due to the Central Limit Theorem. A key reason to utilize the random forest algorithm with skipgram is that it is robust to correlation of features, which is a challenging aspect of generating skipgram features.

Emerging component 506 can also employ sequence modeling which refers to a set of algorithms which exploit sequential structure for behavior which is serially ordered. This behavior can be any sequence of observables where the observable is plausibly dependent on previous (predicted or actual) observables in history. Unlike standard classification algorithms such as Logistic Regression or Support Vector Machines (SVM) which make classifications over isolated observables, sequence modeling algorithms such as Hidden Markov Models (HHM) utilize recent classification decisions to make contextualized classification decisions of behavior. These algorithms often feature a transition function which maps current states to previous states, alongside a local model which maps states to observables and often resembles a static classification algorithm.

The classic algorithm in sequence modeling is the Hidden Markov Model, a generative sequence model which utilizes a probabilistic transition function from states to states and a probabilistic transmission function from states to observables. For example, one could build an HMM of weather-related activities as recorded in a diary in which the diary records the observable activities {Walk, Shop, Clean} on each day and the model attempts to guess which ‘hidden’ state {Rainy, Sunny} maps best onto the observable activity on a particular day.

Sequence modeling is relevant for determining non-compliance and potentially fraudulent behavior as analysts often need to consult the chain of emails leading up to non-compliance to adjudicate cases that would be otherwise ambiguous if only the target email was consulted. Another compelling rationale to utilize a sequence modeling approach is that the linguistic pretext of non-compliance might be more stable than the direct linguistic markers of non-compliance; the received wisdom of fraud risk management analysts is that non-compliant actors evolve the words and phrases they use to transact non-compliance, whereas non-compliant actors are generally under the same pressures to meet sales numbers, which should be evident in the text running up to a potential non-compliance.

A contextualized logistic regression is used in which, for a set of derived variables such as topic and sentiment, the previous context is brought forward as part of the feature vector for classification. For each email (the ‘target’ email’) the set of ten topic variables and sentiment are brought forward, over the following relative time windows: the previous day, the day before, and the non-overlapping previous week, using a set of self-joins (alternatively, npath) on between-statement join criteria for each period, then a group by for each period, at each step aggregating topic variables (by taking any occurrence in the time period as True for that topic, False otherwise) and sentiment variables (taking the average and an absolute count during the period). For each time period, the join, group by, and aggregation was performed separately as experience indicated joining and reducing iteratively was more performant than the naïve solution of all joins followed by all aggregations on large tables.

Evolutionary timescale analysis component 508 can establish establishes unstructured analytic risk scores for users monitored. With each batch refresh, i.e., based on previous day's email data, scores are updated to predict non-compliance. Any significant shifts are noted, observed and triggered for potential review. Thresholds are altered to manage resources. Using advanced visualization, trends are analyzed for sudden shifts, gradual ramp-ups. Unsupervised machine learning algorithms look for new and emerging fraud risk. This is particularly helpful in fraud area where impact is sudden and there is little history.

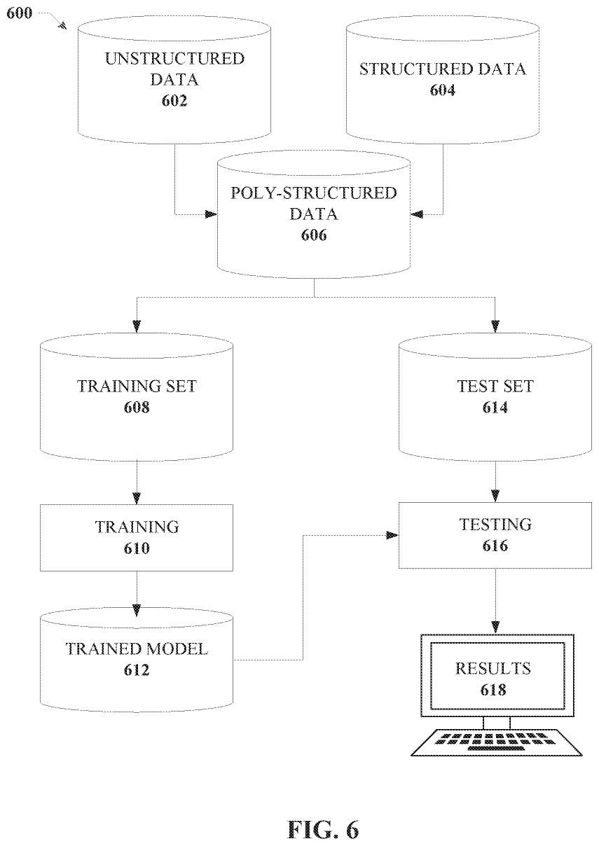

Turning now to FIG. 6, illustrated is an illustration of an example system 600 for fraud risk management using poly-structured data analytics in accordance with one or more aspects of the disclosure. In system 600, a feedback loop is shown for the fraud risk management system disclosed herein. Unstructured data 602 and structured data 604 are combined to create a poly-structured dataset 606. A portion of the dataset 606 is taken to form a training set 608 in order to identify relevant unstructured and structured variables, and to rank the variables in how predictive they are. This is more easily performed with small datasets as the adaptive learning algorithms can be adjusted quicker, and more easily. At 610, the training is performed where the variables are identified, and a finished training model 612 is outputted with the unstructured and structured variables ranked and ordered in a poly-structured data model. The trained model 612 can then be applied to the larger test set of data 614 during testing 616 in order to achieve the noncompliance and fraud risk results 618.

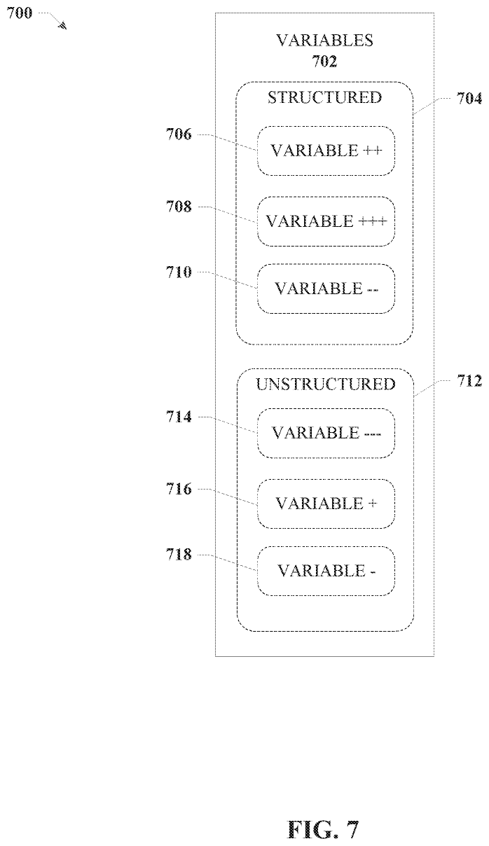

Turning now to FIG. 7, illustrated is an illustration of an example results output 700 of a fraud risk management system in accordance with one or more aspects of the disclosure. A table of variables 702 is shown which shows structured variables 704 and unstructured variables 712 along with their relative risk ratings. Unstructured and structured variables contribute to the overall predictive score. Unstructured model attributes such as variables 714,716, and 718 encompass positive, negative and neutral topics contribute to the score. Structured variables 706, 708, and 710 can include such attributes as application characteristics, fraud scores, previous dispositions, demographic, geographic and survey results. Combinatorial effects of these variables add 18% more lift compared to their respective contributions. A 3 tranch risk index (+++, ++, +, −−−, −−, −) has been developed to show the gradient effects of model variable contribution, thus facilitating quicker and business relevant operationalization.

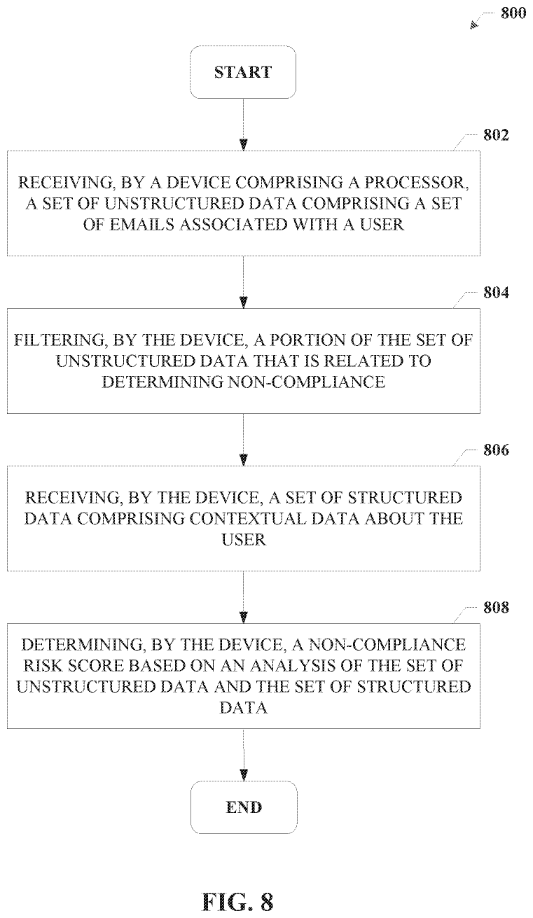

FIG. 8 illustrates a process in connection with the aforementioned systems. The process in FIG. 8 can be implemented for example by systems and methods 100, 200, 300, 400, 500, 600, and 700, illustrated in FIGS. 1-7 respectively. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter

Turning now to FIG. 8, illustrated is an example flow chart of a method 800 for fraud risk management using poly-structured data analytics, according to one or more embodiments.

Method 800 can begin at 802 where the method includes receiving, by a device comprising a processor, a set of unstructured data comprising a set of emails associated with a user. At 804, the method can include filtering, by the device, a portion of the set of unstructured data that is related to determining non-compliance. At 806, the method can include receiving, by the device, a set of structured data comprising contextual data about the user. And at 808, the method can include determining, by the device, a non-compliance risk score based on an analysis of the set of unstructured data and the set of structured data.

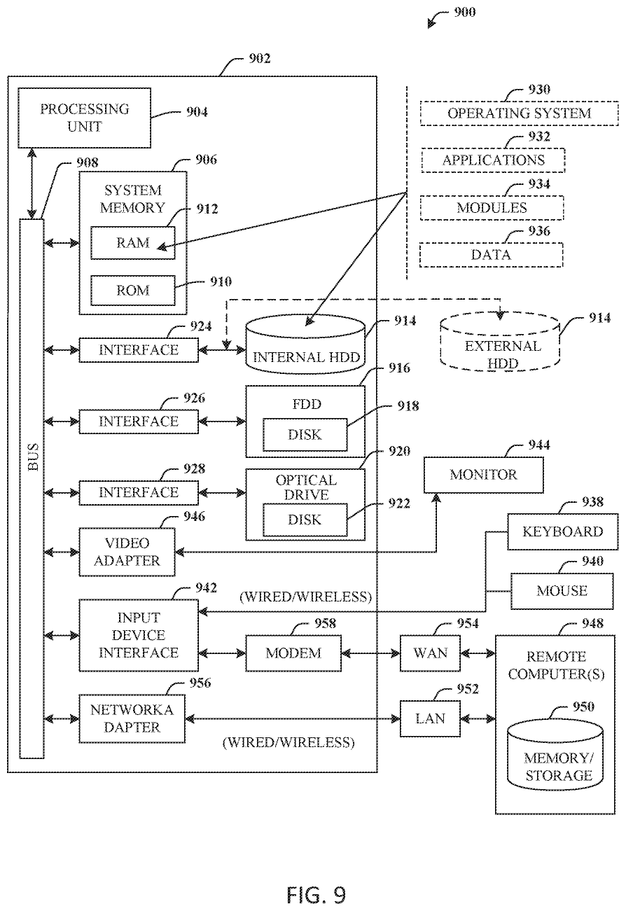

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules or components and/or as a combination of hardware and software.

Generally, program modules include routines, programs, components, data structures, etc., that perform particular tasks or implement particular abstract data types. Moreover, the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. The innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules or components depicted relative to the computer 902, or portions thereof, can be stored in the remote memory/storage device 950. The network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to wired Ethernet networks used in many offices.

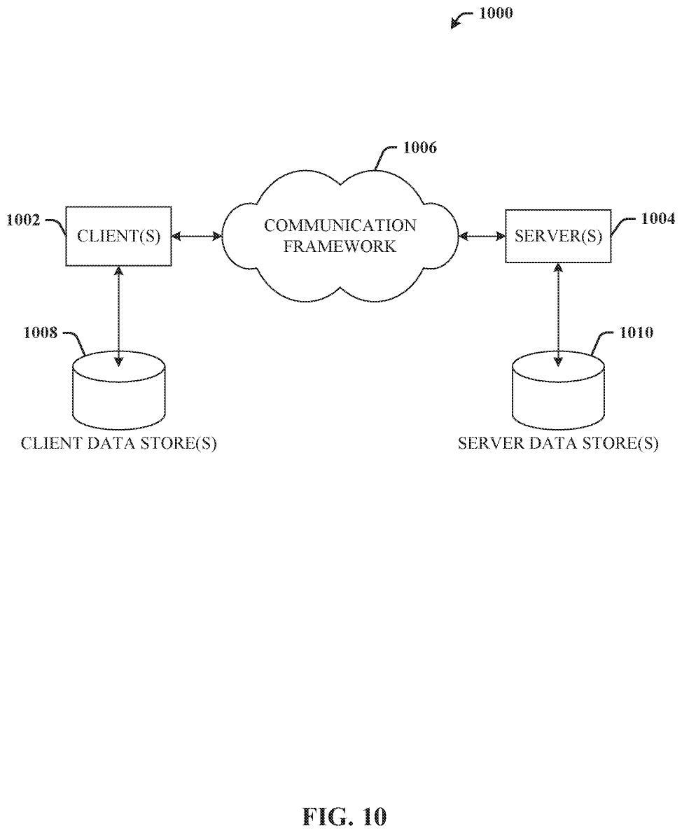

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices).

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002. Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system for performing fraud risk management using poly-structured data analytics comprising:
a memory to store computer-executable instructions; and
a processor, coupled to the memory, to facilitate execution of the computer-executable instructions to perform operations, comprising:
connecting all system devices, components, and memories through a communication network;
receiving a dataset comprising a set of emails associated with a user, wherein the dataset is unstructured data;
performing noise reduction on the dataset, wherein the noise reduction removes a portion of the dataset that is not relevant to fraud risk management;
receiving a set of contextual data associated with the user, wherein the set of contextual data is structured data;
determining a fraud risk score based on an analysis of the dataset and the set of contextual data, wherein the analysis is based on an unstructured variable of the unstructured data and a structured variable of the structured data.

2. The system for performing fraud risk management using poly-structured data analytics of claim 1, wherein the noise reduction comprises at least one of syntactic noise reduction, static semantic noise reduction, and dynamic semantic noise reduction.

3. The system for performing fraud risk management using poly-structured data analytics of claim 1, wherein the unstructured variable is a sentiment score associated with an email in the set of emails.

4. The system for performing fraud risk management using poly-structured data analytics of claim 1, wherein the unstructured variable is based on a word analysis of the dataset.

5. The system for performing fraud risk management using poly-structured data analytics of claim 4, wherein the word analysis is based on skip-gram modeling.

6. The system for performing fraud risk management using poly-structured data analytics of claim 4, wherein the word analysis is based on latent dirichlet allocation modeling.

7. The system for performing fraud risk management using poly-structured data analytics of claim 1, wherein the structured variable is at least one of application volume, compensation, tenure length, loyalty survey scores, loan safe scores, and previous non-compliance.

8. The system for performing fraud risk management using poly-structured data analytics of claim 1, wherein the operations further comprise:
splitting email chains from the dataset into individual emails based on metadata information associated with the email chains.

9. The system for performing fraud risk management using poly-structured data analytics of claim 1, wherein the determining the fraud risk score is based on an analysis of the unstructured variable over a period of time.

10. The system for performing fraud risk management using poly-structured data analytics of claim 9, wherein the operations further comprise:
adjusting the fraud risk score based on the set of contextual data.

11. A method for determining non-compliance using poly-structured data analytics, comprising:
receiving, by a device comprising a processor, a set of unstructured data comprising a set of emails associated with a user;
filtering, by the device, a portion of the set of unstructured data that is related to determining non-compliance;
receiving, by the device, a set of structured data comprising contextual data about the user; and
determining, by the device, a non-compliance risk score based on an analysis of the set of unstructured data and the set of structured data,
wherein one or more of the functions are carried out across multiple devices in a distributed computing environment.

12. The method of claim 11, further comprising:
splitting, by the device, email chains from the set of unstructured data into individual emails based on metadata information associated with the email chains.

13. The method of claim 11, wherein the determining the non-compliance risk score further comprises analyzing an unstructured variable of the set of unstructured data over a period of time.

14. The method of claim 13, wherein the determining the non-compliance risk score further comprises adjusting the non-compliance risk score based on the set of structured data.

15. The method of claim 13, wherein the analyzing the unstructured variable comprises determining a sentiment score associated with an email of the set of emails.

16. The method of claim 13, wherein the analyzing the unstructured variable comprises performing a word analysis on an email of the set of emails.

17. The method of claim 11, wherein the filtering comprises at least one of syntactic noise reduction filtering, static semantic noise reduction filtering, and dynamic semantic noise reduction filtering.

18. A non-transitory computer-readable medium configured to store instructions, that when executed by a processor perform operations, comprising:
receiving a dataset comprising a set of emails associated with a user, wherein the dataset is unstructured data;
performing syntactic noise reduction filtering, static semantic noise reduction filtering, and dynamic semantic noise reduction filtering on the dataset to remove a portion of the dataset that is not relevant to fraud risk management, wherein static noise reduction includes reduction of a dataset based on keywords coupled with footnotes, signatures, and disclaimers;
determining a sentiment score associated with an email of the set of emails;
performing a word analysis on the email of the set of emails, wherein word analysis includes analyzing the dataset based on keywords and key phrases, and also searching, ranking and ordering high risk words, phrases, and themes, and wherein performing word analysis also includes tracking changes in mood, phrases used, and words used over time in order to identify trends which are analyzed for sudden shifts and gradual ramp-ups which can be predictive for non-compliant behavior and fraud;
receiving a set of contextual data associated with the user, wherein the contextual data is structured data; and
determining a fraud risk score based on the sentiment score, the word analysis and a contextual variable of the set of contextual data.

19. The non-transitory computer-readable medium of claim 18, wherein the word analysis is based on skip-gram modeling, latent dirichlet allocation modeling, and maximum entropy text classification modeling.

20. The non-transitory computer-readable medium of claim 18, wherein the contextual variable is at least one of application volume, compensation, tenure length, and previous non-compliance of the user.
